(19) United States
(12) Patent Application Publication
(10) Pub. No.: US 2012/0270002 A1
(43) Pub. Date: Oct. 25, 2012

(54) PRESSURE-SENSITIVE ADHESIVE TAPE FOR FLEXIBLE PRINTED CIRCUIT

(75) Inventors: Hakaru HORIGUCHI, Osaka (JP); Noritsugu DAIGAKU, Osaka (JP); Takahiro NONAKA, Osaka (JP); Rie KUWAHARA, Osaka (JP)

(73) Assignee: NITTO DENKO CORPORATION, Osaka (JP)

(21) Appl. No.: 13/452,067

(22) Filed: Apr. 20, 2012

(30) Foreign Application Priority Data
Apr. 22, 2011 (JP) 2011-096181

(51) Int. Cl. B32B 7/06

(52) U.S. Cl. 428/41.5; 428/41.8

(57) ABSTRACT

The present invention provides a pressure-sensitive adhesive tape for a flexible printed circuit, from which a release liner can be released without being torn off even after being subjected to a high temperature process such as a solder reflow process. The pressure-sensitive adhesive tape of the present invention includes: a pressure-sensitive adhesive layer; and a release liner on at least one surface of the pressure-sensitive adhesive layer, wherein a tensile strength of the release liner in a machine direction is 50 MPa to 150 MPa, and a tensile strength of the release liner in a machine direction after heating at 280° C. for 5 min is 20 MPa to 120 MPa.

### BACKGROUND OF THE INVENTION

1. Technical Field

The present invention relates to a pressure-sensitive adhesive tape to be used for fixing a flexible printed circuit.

2. Background Art

In electronic devices, wiring circuit boards have been used and, as the wiring circuit boards, flexible printed circuits (referred to as “FPC” in some cases) have been widely utilized. The FPC is usually used in a state of being fixed to a housing of an electronic device or a reinforcing plate (such as an aluminum plate, a stainless plate and a polyimide plate). When the FPC is fixed (laminated) to the housing or the reinforcing plate, a pressure-sensitive adhesive tape is used (see Patent Document 1).

In manufacturing the electronic device, an FPC may be subjected to a high temperature process such as a solder reflow process. When subjected to such a high temperature process, a pressure-sensitive adhesive tape including a release liner may be attached to the FPC. Specifically, examples thereof include a case where one surface of a double-sided pressure-sensitive adhesive tape is protected by a release liner, and the other surface of the double-sided pressure-sensitive adhesive tape is laminated to an FPC, and the FPC with the double-sided pressure-sensitive adhesive tape is subjected to a high temperature process, and then the release liner is released therefrom, and the exposed pressure-sensitive adhesive surface is laminated to the housing.

However, in the case where an FPC to which a pressure-sensitive adhesive tape having a release liner is laminated is subjected to a high temperature process, a problem that the release liner is deteriorated by heat during the high temperature process and thus the release liner is torn off (broken), and the like, occurs. The occurrence of such a problem is significant as the heating temperature in the high temperature process increases.

Patent Document 1: JP 2006-302941A

### SUMMARY OF THE INVENTION

Accordingly, the present invention has been made in an effort to provide a pressure-sensitive adhesive tape for a flexible printed circuit, from which a release liner can be released without being torn off even after being subjected to a high temperature process such as a solder reflow process.

Thus, the present inventors have intensively studied in order to solve the problems. As a result, the inventors have found that a pressure-sensitive adhesive tape for a flexible printed circuit, from which a release liner can be released without being torn off even after being subjected to a high temperature process, can be obtained by preparing a pressure-sensitive adhesive tape including a release liner in which, on at least one surface of a pressure-sensitive adhesive layer, a tensile strength in a machine direction is controlled in a predetermined range, and a tensile strength in a machine direction after heating at 280° C. for 5 min is controlled in a predetermined range, thereby completing the present invention.

That is, the present invention provides a pressure-sensitive adhesive tape for a flexible printed circuit, including: a pressure-sensitive adhesive layer; and a release liner on at least one surface of the pressure-sensitive adhesive layer, wherein a tensile strength of the release liner in a machine direction is 50 MPa to 150 MPa, and a tensile strength of the release liner in a machine direction after heating at 280° C. for 5 min is 20 MPa to 120 MPa.

In the pressure-sensitive adhesive tape for a flexible printed circuit, the release liner preferably includes: a glassine paper or a resin coated paper; and a release treatment layer formed by a silicon-based release agent on at least one surface of the glassine paper or the resin coated paper.

In the pressure-sensitive adhesive tape for a flexible printed circuit, the pressure-sensitive adhesive layer preferably includes, as an essential component, an acrylic polymer formed from a monomer component including an acrylic monomer represented by the following formula (I) in an amount of 50 wt % or more based on an entire monomer component (100 wt %) forming the acrylic polymer:

CH₂═C(R¹)COOR² (I)

wherein R¹ represents a hydrogen atom or a methyl group, and R² represents an alkyl group having 4 to 14 carbon atoms.

In the pressure-sensitive adhesive tape for a flexible printed circuit, dimensional change rates of the release liner in both a machine direction and a transverse direction before and after storage for 24 hours under an atmosphere of 60° C. and 90% RH are preferably 2.0% or less.

In the pressure-sensitive adhesive tape, when the pressure-sensitive adhesive tape is cut to have a size of a width of 30 mm and a length of 130 mm, the cut pressure-sensitive adhesive tape is heated at 280° C. for 5 min, and then, the release liner is released from the surface of the pressure-sensitive adhesive layer under the conditions of a release angle of 90° and a tensile speed of 300 mm/min, the release liner can be preferably released from the surface of the pressure-sensitive adhesive layer without being torn off.

In the pressure-sensitive adhesive tape, the silicon-based release agent preferably includes a thermosetting silicon-based release agent.

The pressure-sensitive adhesive tape preferably has a pull tab.

Since the pressure-sensitive adhesive tape for a flexible printed circuit of the present invention has the above configuration, a release liner can be released without being torn off even after being subjected to a high temperature process, and thus, the release liner has excellent release workability. On this account, when the pressure-sensitive adhesive tape for a flexible printed circuit of the present invention is used, productivity or quality of an electronic device having the FPC is improved. In this specification, the “release workability” refers to “easiness of release or easiness of release work” of a release liner.

### BRIEF DESCRIPTION OF THE DRAWINGS

FIG. 1 is a schematic view (plane view) illustrating an example of a state in which the pressure-sensitive adhesive tape for a flexible printed circuit of the present invention having a pull tab is laminated to an adherend.

FIG. 2 is a schematic view (A-A cross-sectional view in FIG. 1) illustrating an example of a state in which the pressure-sensitive adhesive tape for a flexible printed circuit of the present invention having a pull tab is laminated to an adherend.

### DETAILED DESCRIPTION OF THE INVENTION

The pressure-sensitive adhesive tape for a flexible printed circuit of the present invention (hereinafter, simply, referred to as the “pressure-sensitive adhesive tape of the present invention” in some cases) includes a release liner (referred to as the “release liner of the present invention” in some cases), which has a tensile strength in a machine direction of 50 to 150 MPa and a tensile strength in a machine direction after heating at 280° C. for 5 min of 20 to 120 MPa, on at least one side (surface) of a pressure-sensitive adhesive layer. In this specification, the “pressure-sensitive adhesive tape” in principle refers to a pressure-sensitive adhesive tape including a release liner (separator), and “the remaining part in which the release liner is released from the pressure-sensitive adhesive tape” is called an “pressure-sensitive adhesive body” in some cases. A surface of the pressure-sensitive adhesive layer of the pressure-sensitive adhesive body is called an “pressure-sensitive adhesive surface” in some cases. In this specification, the “pressure-sensitive adhesive tape” also includes a sheet type, that is, an “pressure-sensitive adhesive sheet”.

The pressure-sensitive adhesive tape of the present invention may be a double-sided pressure-sensitive adhesive tape in which the release liner of the present invention is provided on at least one pressure-sensitive adhesive surface of a pressure-sensitive adhesive body (double-sided pressure-sensitive adhesive body) with pressure-sensitive adhesive surfaces on both sides thereof, and may be a single-sided pressure-sensitive adhesive tape in which the release liner of the present invention is provided on the pressure-sensitive adhesive surface of a pressure-sensitive adhesive body (single-sided pressure-sensitive adhesive body) with a pressure-sensitive adhesive surface at only one side thereof. Among them, the double-sided pressure-sensitive adhesive tape is preferred from the standpoint of laminating a housing of an electronic device or a reinforcing plate to the FPC.

In the case where the pressure-sensitive adhesive tape of the present invention is a double-sided pressure-sensitive adhesive tape, the release liner of the present invention may be provided on at least one pressure-sensitive adhesive surface of the pressure-sensitive adhesive body and the release liner may not be provided on the other pressure-sensitive adhesive surface. In the case where the release liner of the present invention is provided on one pressure-sensitive adhesive surface of the pressure-sensitive adhesive body (double-sided pressure-sensitive adhesive body) and the release liner is not provided on the other pressure-sensitive adhesive surface (the case of a so-called “single separator type”), a form in which both pressure-sensitive adhesive surfaces of the pressure-sensitive adhesive body are protected with both surfaces of the release liner of the present invention by winding the pressure-sensitive adhesive tape of the present invention in a roll shape may be taken. On the other hand, in the case where release liners are provided on both pressure-sensitive adhesive surfaces of the pressure-sensitive adhesive body (double-sided pressure-sensitive adhesive body), respectively (the case of a so-called “double separator type”), both release liners provided on both pressure-sensitive adhesive surfaces of the pressure-sensitive adhesive body may be a release liner of the present invention, or any one of the release liners may be a release liner other than the release liner of the present invention (hereinafter, referred to as “the other release liner” in some cases).

[Release Liner of the Present Invention]

The tensile strength in a machine direction (referred to as “tensile strength (initial stage) in a machine direction” in some cases) of the release liner of the present invention is 50 MPa to 150 MPa, preferably 60 MPa to 140 MPa, and more preferably 65 MPa to 135 MPa. By controlling the tensile strength (initial stage) in the machine direction to 50 MPa or more, the release liner is not easily torn off during release, and thus, the release workability is improved. On the other hand, the flexibility of the pressure-sensitive adhesive tape may be maintained by controlling the tensile strength (initial stage) in the machine direction to 150 MPa or less, and thus, the workability is improved. Typically, the machine direction of the pressure-sensitive adhesive tape of the present invention (longitudinal direction, MD) (a manufacturing line direction (flow direction) in the manufacturing process of the pressure-sensitive adhesive tape of the present invention) is equal to the machine direction of the release liner of the present invention.

The tensile strength in a machine direction after heating at 280° C. for 5 min (referred to as “tensile strength (after heating) in a machine direction” in some cases) of the release liner of the present invention is 20 MPa to 120 MPa, preferably 30 MPa to 110 MPa, and more preferably 40 MPa to 105 MPa. When the release liner is released, any defects that the release liner is torn off or broken are not caused even after being subjected to a high temperature process by controlling the tensile strength (after heating) in the machine direction to 20 MPa or more, and thus, excellent release workability can be exhibited even after the high temperature process. On the other hand, the flexibility of the pressure-sensitive adhesive tape can be maintained by controlling the tensile strength (after heating) in the machine direction to 120 MPa or less, and thus, the workability is improved.

The tensile strength (initial stage) in the machine direction and tensile strength (after heating) in the machine direction, of the release liner of the present invention, are not particularly limited, but may be controlled by the kind (material) of a liner substrate, the thickness of a liner substrate, the basis weight of a liner substrate, the density of a liner substrate, and the like.

The tensile strength in a transverse direction (referred to as “tensile strength (initial stage) in a transverse direction” in some cases) of the release liner of the present invention is not particularly limited, but is preferably 30 MPa to 120 MPa, and more preferably 35 MPa to 100 MPa. By controlling the tensile strength (initial stage) in the transverse direction to 30 MPa or more, the release liner is not easily torn off during release, and thus, the release workability is improved. On the other hand, the flexibility of the pressure-sensitive adhesive tape may be maintained by controlling the tensile strength (initial stage) in the transverse direction to 120 MPa or less, and thus, the workability is improved.

The tensile strength in a transverse direction after heating at 280° C. for 5 min (referred to as “tensile strength (after heating) in a transverse direction” in some cases) of the release liner of the present invention is not particularly limited, but is preferably 10 MPa to 100 MPa, and more preferably 15 MPa to 90 MPa. When the release liner is released, any defects that the release liner is torn off or broken are hardly caused even after being subjected to a high temperature process by controlling the tensile strength (after heating) in the transverse direction to 10 MPa or more, and thus, the release workability is improved after the high temperature process. On the other hand, the flexibility of the pressure-sensitive adhesive tape can be maintained by controlling the tensile strength (after heating) in the transverse direction to 100 MPa or less, and thus, the workability is improved.

The tensile strength (initial stage) in the transverse direction and tensile strength (after heating) in the transverse direction, of the release liner of the present invention, are not particularly limited, but may be controlled by the kind of a liner substrate, the thickness of a liner substrate, the basis weight of a liner substrate, the density of a liner substrate, and the like.

The tensile strength (tensile strength (initial stage) and tensile strength (after heating) described above can be measured in accordance with JIS P8113. Specifically, the tensile strength can be measured by a method described in “(1) Tensile strength (initial stage) of release liner” and “(2) Tensile strength (after heating) of release liner” in the (Evaluation) as described below.

The dimensional change rate in a machine direction of the release liner of the present invention before and after storage for 24 hours under an atmosphere of 60° C. and 90% RH (referred to as a “dimensional change rate (in a machine direction)” in some cases) is not particularly limited, but is preferably 2.0% or less (for example, 0% to 2.0%), and more preferably 0% to 1.5%. The generation of adhesion failures such as wrinkling, bending and impairment due to a change in dimension after humidification can be prevented by controlling the dimensional change rate (in a machine direction) to 2.0% or less.

The dimensional change rate in a transverse direction of the release liner of the present invention before and after storage for 24 hours under an atmosphere of 60° C. and 90% RH (referred to as a “dimensional change rate (in a transverse direction)” in some cases) is not particularly limited, but is preferably 2.0% or less (for example, 0% to 2.0%), and more preferably 0% to 1.5%. The generation of adhesion failures such as wrinkling, bending, and impairment due to a change in dimension after humidification can be prevented by controlling the dimensional change rate (in a transverse direction) to 2.0% or less.

The dimensional change rate (in a machine direction) and dimensional change rate (in a transverse direction) of the release liner of the present invention are not particularly limited, but may be controlled by the kind (material) of a liner substrate, the thickness of a liner substrate, the basis weight of a liner substrate, the density of a liner substrate, and the like.

The above-described dimensional change rate is a ratio of change in dimension after storage for 24 hours under an atmosphere of 60° C. and 90% RH to the initial dimension (dimension after storage for at least 24 hours under an atmosphere of 23° C. and 50% RH), and is represented by the following equation.

Dimensional Change Rate(%)=(L₁−L_{O})/L₀×100

(where, L₀ is an initial dimension, and L₁ is a dimension after storage for 24 hours under an atmosphere of 60° C. and 90% RH)

The release liner of the present invention is not particularly limited, so long as the tensile strength (initial stage) in the machine direction and the tensile strength (after heating) in the machine direction are controlled within the above-described ranges. Examples of the release liner of the present invention include a release liner in which a release treatment layer is formed on at least one surface of a liner substrate, a low-adhesion release liner including a fluorine-based polymer and a low-adhesion release liner including a non-polarity polymer (for example, an olefin-based polymer, and the like). Among them, from the standpoint of easily controlling the tensile strength or release force of the release liner, the release liner in which the release treatment layer is formed on at least one surface of a liner substrate is preferable. The “liner substrate” in this specification refers to a substrate of the release liner, and is called a “separator base paper” in some cases.

(Liner Substrate)

The liner substrate in the release liner of the present invention is not particularly limited, but various substrates such as, for example, a plastic-based substrate, a paper-based substrate and a fiber-based substrate, may be used. The liner substrate may have any form of a single layer and a multilayer. As the plastic-based substrate, various plastic-based substrates may be properly selected and used, and examples thereof include a polyolefin-based substrate (such as a polyethylene-based substrate and a polypropylene-based substrate), a polyester-based substrate (such as a polyethylene terephthalate-based substrate, a polyethylene naphthalene-based substrate and a polybutylene terephthalate-based substrate), a polyamide-based substrate (such as a so-called “nylon”-based substrate), a cellulose-based substrate (such as a so-called “cellophane”-based substrate), and the like. As the paper-based substrate, various paper-based substrates may be properly selected and used, and examples thereof include Japanese paper, Western paper, high-quality paper, glassine paper, craft paper, Clupak paper, crepe paper, clay-coated paper, synthetic paper, paper in which a resin is coated on the surface of these base papers coated with resin (hereinafter, referred to as “resin coated paper” or “resin coating paper”), and the like. As the fiber-based substrate, various fiber-based substrates may be properly selected and used, and examples thereof include cloth, non-woven cloth, felt, net, and the like. From the standpoint of heat resistance, the paper-based substrate is preferable, and heat-resistant glassine paper and heat-resistant resin coated paper are more preferable among them.

As the liner substrate, heat-resistant resin coated paper is preferable particularly from the standpoint of low deterioration in strength due to heating. The use of the heat-resistant resin coated paper as a liner substrate allows the tensile strength (initial stage) in a machine direction and the tensile strength (after heating) in a machine direction, of the release liner of the present invention, to be easily controlled within the above-described ranges, and makes it difficult to cause defects that the release liner is torn off or broken when released after a high temperature process, and thus, the release workability after a high temperature process is improved.

The heat-resistant resin coated paper in this specification refers to a resin coated paper in which a heat-resistant resin such as an acrylic resin is coated on a surface of high-quality paper, which is a neutral paper. As the heat-resistant resin coated paper, commercially available products such as, for example, a trade name of “HCB-90(WH)” (manufactured by Tomoegawa Paper Co., Ltd.) can also be used.

In the case where the liner substrate is the above-described heat-resistant glassine paper or heat-resistant resin coated paper, the basis weight of the liner substrate is not particularly limited, but is preferably 50 g/m² to 150 g/m², more preferably 60 g/m² to 140 g/m², and even more preferably 70 g/m² to 130 g/m². The strength of the release liner is improved by controlling the basis weight to 50 g/m² or more, and thus, the release liner is not easily torn off or broken when released after a high temperature process. On the other hand, the processability is improved by controlling the basis weight to 150 g/m² or less.

The liner substrate may be subjected to various surface treatments such as a corona discharge treatment on the surface, or may be subjected to various surface processings such as an emboss processing on the surface, if necessary.

The thickness of the liner substrate is not particularly limited, but is preferably 25 μm to 150 μm, more preferably 50 μm to 140 μm, and even more preferably 70 μm to 130 μm. The strength of the release liner is improved by controlling the thickness to 25 μm or more, thereby making it difficult to tear off or break the release liner when the release liner is released after a high temperature process. On the other hand, the processability is improved by controlling the thickness to 150 μm or less.

(Release Treatment Layer)

A release treatment layer in the release liner of the present invention is not particularly limited, but a release treatment layer (silicon-based release treatment layer) formed by a silicon-based release agent (silicon-based release treating agent) is preferable from the standpoint of easily controlling a release property.

The silicon-based release agent is not particularly limited, but examples thereof include ionizing radiation curing silicon-based release agents such as thermosetting silicon-based release agents and ultraviolet-curing silicon-based release agents. From the standpoint of easily decreasing a release force of the release liner to the pressure-sensitive adhesive layer and easily improving the release workability (in particular, the release workability after a high temperature process), the thermosetting silicon-based release agent is preferable among them. On the other hand, in the case where an ultraviolet-curing silicon-based release agent is used as a silicon-based release agent, the release force is relatively increased, and thus, defects that the release liner is torn off when the release liner is released during the release after a high temperature process may be easily caused.

The thermosetting silicon-based release agent is not particularly limited so long as the release agent is a silicon-based release agent with which a crosslinking reaction (curing reaction) is proceeded by heating, but from the standpoint of the release force stability, a thermal addition reaction type silicon-based release agent, which is curable by an addition reaction type crosslinking by heating to form a film having a release property, is preferable. The thermosetting silicon-based release agent may be used either alone or in combination of two or more thereof.

Examples of the thermal addition reaction type silicon-based release agent include silicon-based release agents including, as essential components, polyorganosiloxane which contains an alkenyl group in a molecule thereof (referred to as the “alkenyl group-containing silicone” in some cases) and polyorganosiloxane which contains a hydrosilyl group as a functional group in a molecule thereof (referred to as the “hydrosilyl group-containing silicone” in some cases).

As the alkenyl group-containing silicone, polyorganosiloxane having a structure that an alkenyl group is bonded to a silicon atom forming a main chain or skeleton (for example, a terminal silicon atom, a silicon atom in a main chain thereof, and the like) is preferable, and polyorganosiloxane having two or more alkenyl groups bonded to a silicon atom forming a main chain or skeleton in a molecule thereof (in one molecule) is particularly preferable.

The alkenyl group is not particularly limited, but examples thereof include a vinyl group (ethenyl group), an allyl group (2-propenyl group), a butenyl group, a pentenyl group, a hexenyl group and the like. Among them, the vinyl group and the hexenyl group are preferable.

The polyorganosiloxane forming a main chain or skeleton in the alkenyl group-containing silicone is not particularly limited, but examples thereof include polyalkylalkylsiloxanes (polydialkylsiloxanes) such as polydimethylsiloxane, polydiethylsiloxane, and polymethylethylsiloxane, polyalkylarylsiloxanes and a copolymer of a plurality of silicon atom-containing monomers [for example, poly(dimethylsiloxane-diethylsiloxane)], and the like. Among them, polydimethylsiloxane is preferable. That is, as the alkenyl group-containing silicone, specifically, polydimethylsiloxane having a vinyl group as a functional group, polydimethylsiloxane having a hexenyl group as a functional group, or a mixture thereof is preferable.

As the hydrosilyl group-containing silicone, polyorganosiloxane having a hydrogen atom bonded to a silicon atom forming a main chain or skeleton (for example, a terminal silicon atom, a silicon atom in a main chain thereof, and the like) is preferable, and polyorganosiloxane having two or more hydrogen atoms bonded to a silicon atom forming a main chain or skeleton in a molecule thereof (in one molecule) is particularly preferable. As the above-described hydrosilyl group-containing silicone, specifically, polymethylhydrogensiloxane, poly(dimethylsiloxane-methylhydrogensiloxane) and the like are preferable.

It is preferred that the silicon-based release agent (in particular, thermosetting silicon-based release agent) contains an organic solvent. That is, it is preferred that the silicon-based release agent is a solvent-type silicon-based release agent. The organic solvent is not particularly limited, but from the standpoint of uniformly dissolving components of the silicon-based release agent, examples thereof include hydrocarbon-based solvents (such as alicyclic hydrocarbons and aromatic hydrocarbons) such as cyclohexane, hexane and heptane; aromatic solvents (such as aromatic hydrocarbons) such as toluene and xylene; ester-based solvents (esters) such as ethyl acetate and methyl acetate; ketone-based solvents (ketones) such as acetone and methyl ethyl ketone; alcohol-based solvents (alcohols) such as methanol, ethanol and butanol; and the like. The organic solvent may be used either alone or in combination of two or more thereof.

As the silicon-based release agent, commercially available products such as, for example, a trade name of “KS-847T” (manufactured by Shin-Etsu Chemical Co., Ltd., a thermal addition reaction type silicon-based release agent), a trade name of “KS-774” (manufactured by Shin-Etsu Chemical Co., Ltd., a thermal addition reaction type silicon-based release agent), and a trade name of “KS-841” (manufactured by Shin-Etsu Chemical Co., Ltd., a thermal addition reaction type silicon-based release agent), may also be used.

It is preferred that the silicon-based release agent (in particular, thermosetting silicon-based release agent) contains a catalyst (curing catalyst). The catalyst is not particularly limited, but examples thereof include platinum-based catalysts, tin-based catalysts, and the like. Among them, the platinum-based catalyst is preferable, and at least one platinum-based catalyst selected from chloroplatinic acid, complexes of platinum with olefin, and complexes of chloroplatinic acid with olefin is more preferable. As the platinum-based catalyst, commercially available products such as, for example, a trade name of “PL-50T” (manufactured by Shin-Etsu Chemical Co., Ltd.), and the like, may also be used.

The silicon-based release agent (in particular, thermosetting silicon-based release agent) may contain a reaction inhibitor in order to impart storage stability at room temperature. For example, a reaction inhibitor such as 3,5-dimethyl-hexyne-3-ol, 3-methyl-1-penten-3-ol, 3-methyl-3-penten-1-yn, and 3,5-dimethyl-3-hexen-1-yn, may be used.

The silicon-based release agent (in particular, thermosetting silicon-based release agent) may contain a release control agent if necessary, in addition to the above-described components. For example, the silicon-based release agent may include a release control agent such as MQ resin, and polyorganosiloxane which does not contain any of an alkenyl group and a hydrosilyl group (such as a trimethylsiloxy terminal-blocked polydimethylsiloxane, and the like). The content of the release control agent is not particularly limited, but for example, the content is preferably 10 parts to 50 parts by weight based on the main agent (for example, in the case of a thermal addition reaction type silicon-based release agent, an alkenyl group-containing silicone and a hydrosilyl group containing silicone) (100 parts by weight).

The silicon-based release agent may contain various additive components (additives) if necessary. The additive components are not particularly limited, but examples thereof include a filler, an antistatic agent, an antioxidant, an ultraviolet absorber, a plasticizer and a colorant (pigment, dye and the like).

The release liner of the present invention may be manufactured by a known/general method, and the manufacturing method thereof is not particularly limited but the release liner of the present invention may be manufactured by, for example, forming a release treatment layer on at least one surface of the liner substrate. More specifically, the release liner of the present invention may be manufactured by, for example, applying (coating) the silicon-based release agent on the surface of the liner substrate, followed by drying and/or curing to form a release treatment layer.

In applying (coating) the silicon-based release agent, a general coater (for example, a gravure roll coater, a reverse roll coater, a kiss roll coater, a dip roll coater, a bar coater, a knife coater, a spray coater, and the like) may be used.

The coated amount of release treatment layer (release treatment layer on one surface of the liner substrate) in the release liner of the present invention is not particularly limited, but is preferably 10 g/m² or less (for example, 0.01 g/m² to 10 g/m²), more preferably 0.05 g/m² to 5 g/m², and even more preferably 0.1 g/m² to 3 g/m². The release force may be lowered by controlling the coated amount to 0.01 g/m² or more, and thus, the release workability (in particular, the release workability after a high temperature process) is improved. On the other hand, the release force is not lowered too much by controlling the coated amount to 10 g/m² or less, and thus, the pressure-sensitive adhesive layer may be properly protected. The generation of the siloxane gas from the pressure-sensitive adhesive tape (pressure-sensitive adhesive body) is suppressed. The “coated amount of the release treatment layer” refers to “weight per unit area (1 m²) of the release treatment layer”.

Particularly preferable specific configurations of the release liner of the present invention include the release liner of the following (1) and (2). However, the release liner is not limited thereto.

(1) A release liner in which a release treatment layer is formed by a thermosetting silicon-based release agent on at least one surface of a heat-resistant glassine paper.

(2) A release liner in which a release treatment layer is formed by a thermosetting silicon-based release agent on at least one surface of a heat-resistant resin coated paper.

Although not particularly limited, in the case where the pressure-sensitive adhesive tape of the present invention is a double separator type double-sided pressure-sensitive adhesive tape, the release liner of the present invention is at least preferably a release liner on a side to be released later. In this case, in particular, in the manufacturing process of an electronic device, including the steps of laminating a pressure-sensitive adhesive surface (one pressure-sensitive adhesive surface) exposed by releasing a release liner (a release liner on a side to be released earlier) on one side of a double-sided pressure-sensitive adhesive tape to an FPC, subjecting the FPC to a high temperature process, wherein the FPC has the double-side pressure-sensitive adhesive tape in a state in which the release liner of the present invention is provided on the other pressure-sensitive adhesive surface, and then releasing the release liner of the present invention from the double-sided pressure-sensitive adhesive tape to laminate to the housing, the pressure-sensitive adhesive tape of the present invention may be preferably used. In the manufacturing process, when the release liner of the present invention is released after the high temperature process, defects that the release liner is torn off or broken are not caused, and thus, the workability (in particular, release workability) or productivity is improved.

[Other Release Liner]

As described above, in the case where the pressure-sensitive adhesive tape of the present invention is a double-sided pressure-sensitive adhesive tape, the pressure-sensitive adhesive tape may include other release liner (a release liner other than the release liner of the present invention). The other release liner is not particularly limited, and any known/general release liner may be used.

Although not particularly limited, in the case where the pressure-sensitive adhesive tape of the present invention is a double separator type double-sided pressure-sensitive adhesive tape and includes other release liner, the other release liner is preferably used as a release liner to be released earlier.

[Pressure-Sensitive Adhesive Body]

The pressure-sensitive adhesive body in the pressure-sensitive adhesive tape of the present invention may be a “substrateless type pressure-sensitive adhesive body” that does not have a substrate (substrate layer) or a “pressure-sensitive adhesive body with a substrate” that has a substrate. Examples of the substrateless type pressure-sensitive adhesive body include a pressure-sensitive adhesive body consisting of only the pressure-sensitive adhesive layer (double-sided pressure-sensitive adhesive body), and the like. On the other hand, examples of the pressure-sensitive adhesive body with a substrate include a pressure-sensitive adhesive body having the pressure-sensitive adhesive layer on only one surface of the substrate (single-sided pressure-sensitive adhesive body) or a pressure-sensitive adhesive body having the pressure-sensitive adhesive layers on both surfaces of the substrate (double-sided pressure-sensitive adhesive body).

The thickness of the pressure-sensitive adhesive body is not particularly limited, but is preferably 10 μm to 70 μm, more preferably 15 μm to 65 μm, and particularly preferably 20 μm to 60 μm. The stress generated during lamination is easily dispersed by controlling the thickness to 10 μm or more, thereby making it difficult to occur the release. On the other hand, the product is advantageously miniaturized or made thinner by controlling the thickness to 70 μm or less.

(Pressure-Sensitive Adhesive Layer)

The pressure-sensitive adhesive for forming the pressure-sensitive adhesive layer in the pressure-sensitive adhesive body is not particularly limited, but a known pressure-sensitive adhesive such as, for example, an acrylic pressure-sensitive adhesive, a rubber-based pressure-sensitive adhesive, a vinyl alkyl ether-based pressure-sensitive adhesive, a silicon-based pressure-sensitive adhesive, a polyester-based pressure-sensitive adhesive, a polyamide-based pressure-sensitive adhesive, a urethane-based pressure-sensitive adhesive, a fluorine-based pressure-sensitive adhesive and an epoxy-based pressure-sensitive adhesive, may be used. The pressure-sensitive adhesive may be used either alone or in combination of two or more thereof. On the other hand, the pressure-sensitive adhesive may be a pressure-sensitive adhesive having any form, and for example, an emulsion type pressure-sensitive adhesive, a solvent type (solution type) pressure-sensitive adhesive, an active energy-ray curable pressure-sensitive adhesive, a hot melt pressure-sensitive adhesive and the like, may be used.

Among them, the pressure-sensitive adhesive for forming the pressure-sensitive adhesive layer is preferably an acrylic pressure-sensitive adhesive from the standpoint of heat resistance and release workability after a high temperature process. That is, it is preferred that the pressure-sensitive adhesive layer is a pressure-sensitive adhesive layer (acrylic pressure-sensitive adhesive layer) including an acrylic polymer as an essential component. It is preferred that the pressure-sensitive adhesive layer (acrylic pressure-sensitive adhesive layer) is formed from a pressure-sensitive adhesive composition (acrylic pressure-sensitive adhesive composition) including an acrylic polymer as an essential component. The content of the acrylic polymer in the pressure-sensitive adhesive layer (acrylic pressure-sensitive adhesive layer)(100 wt %) is not particularly limited, but is preferably 65 wt % or more (for example, 65 to 90 wt %) and more preferably 68 to 87 wt %.

The acrylic polymer is preferably an acrylic polymer formed from a component including, as an essential monomer component (monomer component), an acrylic monomer represented by the following formula (I).

CH₂═C(R¹)COOR² (I)

In the formula (I), R¹ is a hydrogen atom or a methyl group. R² is an alkyl group having 4 to 14 carbon atoms. Examples of R² include an n-butyl group, an isobutyl group, an s-butyl group, a t-butyl group, a pentyl group, an isopentyl group, a hexyl group, a heptyl group, an octyl group, a 2-ethylhexyl group, an isooctyl group, a nonyl group, an isononyl group, a decyl group, an isodecyl group, an undecyl group, a dodecyl group, a tridecyl group, a tetradecyl group and the like.

Specifically, examples of the acrylic monomer represented by the formula (I) include n-butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate and the like. The acrylic monomer represented by the formula (I) may be used either alone or in combination of two or more thereof. Among them, 2-ethylhexyl acrylate (2EHA) and n-butyl acrylate are preferable. The “(meth)acryl” represents “acryl” and/or “methacryl” (any one or both of “acryl” and “methacryl”) and the same also applies to the others.

The content of the acrylic monomer represented by the formula (I) is not particularly limited, but is preferably 50 wt % or more (for example, 50 wt % to 99 wt %), more preferably 80 wt % to 98 wt %, and even more preferably 85 wt % to 98 wt % based on the entire monomer components (100 wt %) forming the acrylic polymer. Characteristics (such as pressure-sensitive adhesiveness) as the acrylic polymer are easily exhibited by controlling the content to 50 wt % or more.

In the monomer component forming the acrylic polymer, a polar group-containing monomer, a polyfunctional monomer or other monomers may also be included as a copolymerizable monomer component (a copolymerizable monomer component to the acrylic monomer represented by the formula (I)). By using these copolymerizable monomer components, for example, the adhesion force to the adherend may be improved or the cohesion force of the pressure-sensitive adhesive layer may be increased.

Examples of the polar group-containing monomer include carboxyl group-containing monomers (also including acid anhydride group-containing monomers such as maleic anhydride and itaconic anhydride) such as (meth)acrylic acid, itaconic acid, maleic acid, fumaric acid, crotonic acid, and isocrotonic acid and the like; hydroxyl group-containing monomers including hydroxyalkyl (meth)acrylates such as 2-hydroxyethyl (meth)acrylate, 3-hydroxypropyl (meth)acrylate, 4-hydroxybutyl (meth)acrylate, and 6-hydroxyhexyl (meth)acrylate, vinyl alcohol, allyl alcohol and the like; amide group-containing monomers such as (meth)acrylamide, N,N-dimethyl (meth) acrylamide, N-methylol (meth) acrylamide, N-methoxymethyl (meth) acrylamide, N-butoxymethyl (meth)acrylamide and N-hydroxyethyl acrylamide; amino group-containing monomers such as aminoethyl (meth)acrylate, dimethylaminoethyl (meth)acrylate and t-butylaminoethyl (meth)acrylate; glycidyl group-containing monomers such as glycidyl (meth)acrylate and methylglycidyl (meth)acrylate; cyano group-containing monomers such as acrylonitrile and methacrylonitrile; hetero ring-containing vinyl monomers such as vinylpyridine, N-vinylpiperidone, vinylpyrimidine, N-vinylpiperazine, N-vinylpyrrole, N-vinylimidazole, and vinyloxazole in addition to N-vinyl-2-pyrrolidone and (meth)acryloyl morpholine; alkoxyalkyl (meth)acrylate monomers such as methoxyethyl (meth)acrylate and ethoxyethyl (meth)acrylate; sulfonic acid group-containing monomers such as sodium vinylsulfonate; phosphoric acid group-containing monomers such as 2-hydroxyethyl acryloyl phosphate; imide group-containing monomers such as cyclohexyl maleimide and isopropyl maleimide; and isocyanate group-containing monomers such as 2-methacryloyloxyethyl isocyanate; and the like. The polar group-containing monomer may be used either alone or in combination of two or more thereof. Among them, as the polar group-containing monomer, a carboxyl group-containing monomer is preferable and acrylic acid (AA) is more preferable.

The content of the polar group-containing monomer is not particularly limited, but is preferably 1 wt % to 50 wt %, more preferably 2 wt % to 20 wt %, and even more preferably 2 wt % to 15 wt % based on the entire monomer components (100 wt %) forming the acrylic polymer. The cohesion force is improved by controlling the content of the polar group-containing monomer to 1 wt % or more. On the other hand, the pressure-sensitive adhesive layer is not too hard by controlling the content of the polar group-containing monomer to 50 wt % or less, thereby improving the pressure-sensitive adhesive force.

The polyfunctional monomer is a monomer having two or more ethylenically unsaturated groups (organic groups including a carbon-carbon double bond) in a molecule thereof (in one molecule). The ethylenically unsaturated group is not particularly limited, but examples thereof include a (meth)acryloyl group, an alkenyl group (a vinyl group (an ethenyl group), an allyl group (a 2-propenyl group), a butenyl group, a pentenyl group, a hexenyl group, and the like), and the like. Specifically, examples of the polyfunctional monomer include hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl (meth)acrylate, vinyl (meth)acrylate, divinylbenzene, epoxy acrylate, polyester acrylate, urethane acrylate and the like.

The content of the polyfunctional monomer is not particularly limited, but is preferably 0.5 wt % or less (for example, 0 to 0.5 wt %) and more preferably 0 to 0.3 wt % based on the entire monomer components (100 wt %) forming the acrylic polymer. The cohesion force of the pressure-sensitive adhesive layer is not increased too high by controlling the content of the polyfunctional monomer to 0.5 wt % or less, thereby improving the pressure-sensitive adhesive force. In the case where a crosslinking agent is used, the polyfunctional monomer may not be used. However, in the case where a crosslinking agent is not used, the content of the polyfunctional monomer is preferably 0.001 wt % to 0.5 wt % and more preferably 0.002 wt % to 0.1 wt % based on the entire monomer component (100 wt %) forming the acrylic polymer.

Examples of the monomers other than the polar group-containing monomers and the polyfunctional monomers include alkyl ester (meth)acrylates whose alkyl group has 1 to 3 carbon atoms, such as methyl (meth)acrylate, ethyl (meth)acrylate, propyl (meth)acrylate and isopropyl (meth)acrylate; alkyl ester (meth)acrylates whose alkyl group has 15 to 20 carbon atoms, such as pentadecyl (meth)acrylate, hexadecyl (meth)acrylate, heptadecyl (meth)acrylate, octadecyl (meth)acrylate, nonadecyl (meth)acrylate and eicosyl (meth)acrylate; ester (meth)acrylates having an alicylic hydrocarbon group, such as cyclopentyl (meth)acrylate, cyclohexyl (meth)acrylate, and isobornyl (meth)acrylate; aryl ester (meth)acrylates such as phenyl (meth)acrylate; vinyl esters such as vinyl acetate and vinyl propionate; aromatic vinyl compounds such as styrene and vinyltoluene; olefins or dienes such as ethylene, butadiene, isoprene and isobutylene; vinyl ethers such as vinyl alkyl ether; vinyl chloride; and the like.

The acrylic polymer may be manufactured by polymerizing the monomer components using a known/general polymerization method. As the polymerization of the acrylic polymer, examples thereof include a solution polymerization, an emulsion polymerization, a bulk polymerization, a polymerization by an active energy-ray irradiation (active energy-ray polymerization) or the like. Among them, from the standpoint of transparency, water resistance, cost or the like, the solution polymerization and the active energy-ray polymerization are preferable, and the solution polymerization is more preferable.

In the solution polymerization, various kinds of general solvents may be used. As the solvents, examples thereof include organic solvents, such as esters such as ethyl acetate and n-butyl acetate; aromatic hydrocarbons such as toluene and benzene; aliphatic hydrocarbons such as n-hexane and n-heptane; alicyclic hydrocarbons such as cyclohexane and methylcyclohexane; and ketones such as methylethylketone and methylisobutylketone. The solvents may be used either alone or in combination of two or more thereof.

A polymerization initiator used in the polymerization of the acrylic polymer is not particularly limited and may be properly selected from known/general initiators and used. As the polymerization initiator, preferable examples thereof include an oil-soluble polymerization initiator, such as an azo-based polymerization initiator such as 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), 1,1′-azobis(cyclohexane-1-carbonitrile), 2,2′-azobis(2,4,4-trimethylpentane) and dimethyl-2,2′-azobis(2-methylpropionate); and a peroxide-based polymerization initiator such as benzoylperoxide, t-butylhydroperoxide, di-t-butylperoxide, t-butylperoxybenzoate, dicumylperoxide, 1,1-bis(t-butylperoxy)-3,3,5-trimethylcyclohexane and 1,1-bis(t-butylperoxy)cyclododecane. The polymerization initiator may be used either alone or in combination of two or more thereof. The used amount of the polymerization initiator is not particularly limited, and may be used within a range available as a polymerization initiator in the related art.

The glass transition temperature (Tg) of the acrylic polymer is not particularly limited, but is preferably −70° C. to −30° C. and more preferably −65° C. to −35° C. The heat resistance is improved by controlling the glass transition temperature to −70° C. or more. On the other hand, the pressure-sensitive adhesive layer is not too hard by controlling the glass transition temperature to −30° C. or less, thereby improving the pressure-sensitive adhesive force. The glass transition temperature of the acrylic polymer can be controlled by, for example, a kind or content of monomer forming the acrylic polymer, and the like.

The glass transition temperature (Tg) of the acrylic polymer is a glass transition temperature (theoretical value) represented by the following equation.

1/Tg=W₁/Tg₁+W₂/Tg₂+ . . . +Wₙ/Tgₙ

In the above equation, Tg represents a glass transition temperature (unit: K) of the acrylic polymer, Tg; represents a glass transition temperature (unit: K) when a monomer i forms a homopolymer, and Wᵢ represents a weight fraction of the monomer i (i=1, 2, . . . n) in the entire monomer components. The equation is an equation in the case where the acrylic polymer is configured by n kinds of monomer components such as monomer 1, monomer 2, . . . , monomer n.

The weight average molecular weight of the acrylic polymer is not particularly limited, but is preferably 400,000 to 1,500,000, more preferably 450,000 to 1,400,000, and even more preferably 500,000 to 1,300,000. The cohesion force is improved by controlling the weight average molecular weight of the acrylic polymer to 400,000 or more. On the other hand, the coatability is improved by controlling the weight average molecular weight to 1,500,000 or less. The weight average molecular weight of the acrylic polymer can be controlled by a kind or used amount of the polymerization initiator, a temperature or time at polymerization, a monomer concentration, a monomer dropping rate, or the like.

The weight average molecular weight can be measured by a gel permeation chromatography (GPC) method. Specifically, the weight average molecular weight can be measured according to the following method and conditions.

(Preparation Method of Sample)

The acrylic polymer is dissolved in the following eluent to prepare a 0.1% DMF solution, which is left to stand overnight, followed by filtration with a membrane filter of 0.45 and a GPC measurement is performed on the filtrate.

(Measuring Conditions)

GPC device: HLC-8120GPC (manufactured by Tosoh Corporation)

Column: TSKgel superAWM-H, TSKgel superAW4000, and TSKgel superAW2500 (manufactured by Tosoh Corporation)

Column size: Each 6 mmφ×15 cm, Total 45 cm

Column temperature: 40° C.

Eluent: 10 mM-LiBr, 10 mM-phosphoric acid/DMF

Flow rate: 0.4 mL/min

Inlet pressure: 4.6 MPa

Injection amount: 20 μL

Detector: Refractive Index (RI) detector

Standard sample: Polyethylene oxide

Data processing device: GPC-8020 (manufactured by Tosoh Corporation)

It is preferred that the pressure-sensitive adhesive composition for forming the pressure-sensitive adhesive layer of the pressure-sensitive adhesive tape of the present invention contains a crosslinking agent. The crosslinking agent may be used to crosslink a base polymer (for example, acrylic polymer) constituting the pressure-sensitive adhesive layer, thereby significantly increasing the cohesion force of the pressure-sensitive adhesive layer. The crosslinking agent used may be properly selected from known/general crosslinking agents, and is not particularly limited. Specifically, for example, a polyfunctional melamine compound (melamine-based crosslinking agent), a polyfunctional epoxy compound (epoxy-based crosslinking agent), a polyfunctional isocyanate compound (isocyanate-based crosslinking agent) and the like are preferably used. The crosslinking agent may be used either alone or in combination of two or more thereof. Among them, from the standpoint of reactivity, the isocyanate-based crosslinking agent and the epoxy-based crosslinking agent are preferable, and the epoxy-based crosslinking agent is more preferable.

Examples of the isocyanate-based crosslinking agents include lower aliphatic polyisocyanates such as 1,2-ethylene diisocyanate, 1,4-butylene diisocyanate and 1,6-hexamethylene diisocyanate; alicyclic polyisocyanates such as cyclopentylene diisocyanate, cyclohexylene diisocyanate, isophorone diisocyanate, hydrogenated tolylene diisocyanate and hydrogenated xylene diisocyanate; and aromatic polyisocyanates such as 2,4-tolylene diisocyanate, 2,6-tolylene diisocyanate, 4,4′-diphenylmethane diisocyanate and xylene diisocyanate. The examples thereof may include an adduct of trimethylolpropane/tolylene diisocyanate (trade name of ‘Coronate L’, manufactured by Nippon Polyurethane Industry Co., Ltd.); and an adduct of trimethylolpropane/hexamethylene diisocyanate (trade name of ‘Coronate HL’, manufactured by Nippon Polyurethane Industry Co., Ltd.).

Examples of the epoxy-based crosslinking agents include N,N,N′,N′-tetraglycidyl-m-xylenediamine, diglycidylaniline, 1,3-bis(N,N-diglycidylaminomethyl)cyclohexane, 1,6-hexandioldiglycidylether, neopentyl glycol diglycidyl ether, ethylene glycol diglycidyl ether, propylene glycol diglycidyl ether, polyethylene glycol diglycidyl ether, polypropylene glycol diglycidyl ether, sorbitol polyglycidyl ether, glycerol polyglycidyl ether, pentaerythritol polyglycidyl ether, polyglycerol polyglycidyl ether, sorbitan polyglycidyl ether, trimethylol propane polyglycidyl ether, adipic acid diglycidyl ester, o-phthalic acid diglycidyl ester, triglycidyl-tris(2-hydroxyethyl)isocyanurate, resorsin diglycidyl ether, bisphenol-S-diglycidylether, and epoxy-based resins having two or more epoxy groups in molecules thereof. As commercially available products thereof, examples thereof include a trade name of ‘Tetrad-C’ manufactured by Mitsubish Gas Chemical Company Inc.

The content of the crosslinking agent in the pressure-sensitive adhesive composition is not particularly limited. However, in the case of the epoxy-based crosslinking agent, the content is preferably 0.02 parts to 0.1 parts by weight and more preferably 0.03 parts to 0.08 parts by weight based on 100 parts by weight of the acrylic polymer. The cohesion force of the pressure-sensitive adhesive layer is improved by controlling the content of the crosslinking agent to 0.02 parts by weight or more. On the other hand, the pressure-sensitive adhesive layer is not too hard by controlling the content to 0.1 parts by weight or less, thereby improving the pressure-sensitive adhesive force.

From the standpoint of improving adhesion property, it is preferred that the pressure-sensitive adhesive composition contains a tackifying resin (tackifier). Examples of the tackifying resin include a terpene-based tackifying resin, a phenol-based tackifying resin, a rosin-based tackifying resin, a petroleum-based tackifying resin and the like. Among them, the terpene-base tackifying resin is preferable. The tackifying resins may be used either alone or in combination of two or more thereof.

Examples of the terpene-based tackifying resin include terpene-based resins such as an α-pinene polymer, a β-pinene polymer and a dipentene polymer, or modified terpene-based resins (for example, a terpene-phenol-based resin, a styrene-modified terpene-based resin, an aromatic-modified terpene-based resin, a hydrogenated terpene-based resin and the like) obtained by modifying the terpene-based resins through modification (phenol modification, aromatic modification, hydrogenation modification, hydrocarbon modification, and the like), and the like.

Examples of the phenol-based tackifying resin include condensates (for example, an alkyl-phenol resin, a xylene-formaldehyde resin, and the like) of various phenols (for example, phenol, m-cresol, 3,5-xylenol, p-alkylphenol, resorcin and the like) and formaldehyde; resols obtained by addition reaction of the phenols and formaldehyde using an alkali catalyst; novolacs obtained by condensation reaction of the phenols and formaldehyde using an acid catalyst; and rosin-modified phenol resins obtained by adding phenol to rosins (an unmodified rosin, a modified rosin, various rosin derivatives and the like) using an acid catalyst and thermal polymerizing the same, and the like.

Examples of the rosin-based tackifying resin include an unmodified rosin (natural rosin) such as gum rosin, wood rosin and tall oil rosin, a modified rosin (e.g., hydrogenated rosin, disproportionated rosin, polymerized rosin, or other chemically modified rosins) obtained by modifying the unmodified rosin above through hydrogenation, disproportionation, polymerization or the like, and various rosin derivatives. Examples of the rosin derivative include rosin esters, for example, a rosin ester compound obtained by esterifying an unmodified rosin with alcohols, and a modified rosin ester compound obtained by esterifying a modified rosin (e.g., hydrogenated rosin, disproportionated rosin, or polymerized rosin) with alcohols; unsaturated fatty acid-modified rosins obtained by modifying an unmodified rosin or a modified rosin (e.g., hydrogenated rosin, disproportionated rosin, or polymerized rosin) with an unsaturated fatty acid; unsaturated fatty acid-modified rosin esters obtained by modifying rosin esters with an unsaturated fatty acid; rosin alcohols obtained by reducing the carboxyl group in unmodified rosins, modified rosins (e.g., hydrogenated rosin, disproportionated rosin, or polymerized rosin), unsaturated fatty acid-modified rosins or unsaturated fatty acid-modified rosin esters; and metal salts of rosins (particularly, rosin esters) such as unmodified rosin, modified rosin and various rosin derivatives.

Examples of the petroleum-based tackifying resin include a known petroleum resin such as aromatic petroleum resin, aliphatic petroleum resin, alicyclic petroleum resin (aliphatic cyclic petroleum resin), aliphatic.aromatic petroleum resin, aliphatic.alicyclic petroleum resin, hydrogenated petroleum resin, coumarone-based resin and coumarone-indene-based resin. More specifically, examples of the aromatic petroleum resin include a polymer using only one species or two or more species of vinyl group-containing aromatic hydrocarbons having a carbon number of 8 to 10 (e.g., styrene, o-vinyltoluene, m-vinyltoluene, p-vinyltoluene, α-methylstyrene, β-methylstyrene, indene, and methylindene). As the aromatic petroleum resin, an aromatic petroleum resin (so-called “C9 petroleum resin”) obtained from a fraction (so-called “C9 petroleum fraction”) such as vinyl toluene and indene may be suitably used. Examples of the aliphatic petroleum resin include a polymer using only one species or two or more species of olefins or dienes having a carbon number of 4 to 5 (for example, an olefin such as butene-1, isobutylene and pentene-1; and a diene such as butadiene, piperylene (1,3-pentadiene) and isoprene). As the aliphatic petroleum resin, an aliphatic petroleum resin (so-called “C4 petroleum resin” or “C5 petroleum resin”) obtained from a fraction (so-called “C4 petroleum fraction” or “C5 petroleum fraction”) such as butadiene, piperylene and isoprene may be suitably used. Examples of the alicyclic petroleum resin include an alicyclic hydrocarbon-based resin obtained by cyclizing and dimerizing an aliphatic petroleum resin (so-called “C4 petroleum resin” or “C5 petroleum resin”) and then polymerizing the dimer, a polymer of cyclic diene compound (e.g., cyclopentadiene, dicyclopentadiene, ethylidene norbornene, dipentene, ethylidene bicycloheptene, vinylcycloheptene, tetrahydroindene, vinylcyclohexene, or limonene), a hydrogenation product thereof, and an alicyclic hydrocarbon-based resin obtained by hydrogenating the aromatic ring in the above-described aromatic hydrocarbon resin or the aliphatic-aromatic petroleum resin described below. Examples of the aliphatic-aromatic petroleum resin include a styrene-olefin-based copolymer. As the aliphatic-aromatic petroleum resin, a so-called “C5/C9 copolymer petroleum resin” or the like may be used.

As the tackifying resin, commercially available products may be used, and for example, a trade name of “YS PolystarS145” (manufactured by Yasuhara Chemical Co., Ltd., a terpene-phenol-based resin, softening point 145° C.) and the like can be used.

The content of the tackifying resin in the pressure-sensitive adhesive composition is not particularly limited, but is preferably 10 parts by weight to 50 parts by weight, and more preferably 12 parts by weight to 45 parts by weight based on the acrylic polymer (100 parts by weight). The pressure-sensitive adhesive force is improved by controlling the content to 10 parts by weight or more. On the other hand, the cohesion force of the pressure-sensitive adhesive layer is improved by controlling the content to 50 parts by weight or less.

The pressure-sensitive adhesive composition may contain known additives such as a crosslinking accelerator, an anti-aging agent, a filler, a colorant (pigment, dye and the like), an ultraviolet absorber, a chain transfer agent, a plasticizer, a softener, a surfactant and an antistatic agent, and solvents (solvents which can be used during solution polymerization of the above-described acrylic polymer and the like), if necessary.

The preparation of the pressure-sensitive adhesive composition is not particularly limited, but the pressure-sensitive adhesive composition can be prepared, for example, by mixing an acrylic polymer (or an acrylic polymer solution) with a crosslinking agent or other additives.

The method for forming a pressure-sensitive adhesive layer of the pressure-sensitive adhesive body in the pressure-sensitive adhesive tape of the present invention is not particularly limited, but may include a method of applying (coating) the pressure-sensitive adhesive composition on a substrate or a release liner, and if necessary, drying and/curing the composition.

In the application (coating) in the method for forming the pressure-sensitive adhesive layer, a known coating method may be used, and a known coater, for example, a gravure roll coater, a reverse roll coater, a kiss roll coater, a dip roll coater, a bar coater, a knife coater, a spray coater, a comma coater, a direct coater and the like may be used.

The thickness of the pressure-sensitive adhesive layer is not particularly limited, but is preferably 10 μm to 70 μm, more preferably 15 μm to 65 μm, and even more preferably 20 μm to 60 μm. The stress generated during lamination is easily dispersed by controlling the thickness to 10 μm or more, thereby making it difficult to occur the release. On the other hand, the product is advantageously miniaturized or made thinner by controlling the thickness to 70 μm or less.

A gel fraction of the pressure-sensitive adhesive layer is not particularly limited, but is preferably 20% to 70% (wt %) and more preferably 28% to 65%. The gel fraction may be measured as an insoluble matter of ethyl acetate, and specifically, is measured as a weight fraction (unit: wt %) of an insoluble matter after the pressure-sensitive adhesive layer is immersed in ethyl acetate at 23° C. for 7 days to the sample before immersing. The cohesion force of the pressure-sensitive adhesive layer is improved by controlling the gel fraction to 20% or more. On the other hand, the pressure-sensitive adhesive layer is not too hard by controlling the gel fraction to 70% or less, thereby improving the pressure-sensitive adhesive force.

The gel fraction (proportion of the solvent-insoluble part) is specifically a value calculated, for example, by the following “Gel Fraction Measuring Method”.

### (Gel Fraction Measuring Method)

About 0.1 g of the pressure-sensitive adhesive layer is sampled from the pressure-sensitive adhesive tape, wrapped with a porous tetrafluoroethylene sheet (trade name of “NTF1122”, manufactured by Nitto Denko Corporation) having an average pore size of 0.2 μm, and it is tied up with a kite string and at this time, it is measured for the weight, and the weight measured is designated as the weight before immersion. The weight before immersion is the total weight of the pressure-sensitive adhesive layer (pressure-sensitive adhesive sampled above), the tetrafluoroethylene sheet and the kite string. The total weight of the tetrafluoroethylene sheet and the kite string is also measured, and this weight is designated as the wrapper weight.

Subsequently, the pressure-sensitive adhesive layer wrapped with a tetrafluoroethylene sheet and tied up with a kite string (hereinafter referred to as the “sample”) is put in a 50 ml-volume vessel filled with ethyl acetate, followed by allowing to stand still at 23° C. for 7 days. The sample (after ethyl acetate treatment) is then taken out of the vessel, and it is transferred to an aluminum-made cup, followed by drying in a dryer at 130° C. for 2 hours to remove ethyl acetate, and it is measured for the weight, and this weight is designated as the weight after immersion.

The gel fraction is calculated according to the following formula:

Gel fraction(wt %)=((A−B)/(C−B))×100

(wherein A is the weight after immersion, B is the wrapper weight, and C is the weight before immersion).

The gel fraction can be controlled by, for example, a monomer composition or weight average molecular weight of an acrylic polymer and a used amount (added amount) of a crosslinking agent.

A peak temperature of a loss tangent (tan δ) measured by measurement of dynamic viscoelasticity of the pressure-sensitive adhesive layer (a temperature at which the loss tangent (tan δ) shows a local maximum value) is not particularly limited, but is preferably −20 to 30° C., more preferably −18 to 25° C., and even more preferably −15 to 20° C. The heat resistance is improved by controlling the peak temperature of the loss tangent (tan δ) to −20° C. or more. On the other hand, the pressure-sensitive adhesive layer is not too hard by controlling the peak temperature of the loss tangent (tan δ) to 30° C. or less, thereby improving the pressure-sensitive adhesive force. The peak temperature of the loss tangent (tan δ) of the pressure-sensitive adhesive layer is measured by measurement of dynamic viscoelasticity. For example, the peak temperature thereof can be measured by “Advanced Reometric Expansion System (ARES)” manufactured by Reometric Scientific Co., Ltd. in the shear mode under conditions of a frequency of 1 Hz, a range of −70° C. to 200° C., and a rising-temperature rate of 5° C./min after laminating a plurality of pressure-sensitive adhesive layers such that the layers has a thickness of about 1.5 mm.

The peak temperature of the loss tangent (tan δ) of the pressure-sensitive adhesive layer can be controlled by, for example, a monomer composition of an acrylic polymer, a kind or content of a tackifying resin, or the like.

[Substrate]

In the case where the pressure-sensitive adhesive body in the pressure-sensitive adhesive tape of the present invention is a pressure-sensitive adhesive body with a substrate, the substrate is not particularly limited, but is preferably, for example, a substrate with heat resistance. Specifically, a fiber-based substrate such as cloth, non-woven cloth, felt and net; a paper-based substrate such as various papers; a metal-based substrate such as a metal foil and a metal plate; a plastic-based substrate such as film and sheet of various resins (such as a polyolefin-based resin, a polyester-based resin, a polyvinyl chloride-based resin, a polyvinyl acetate-based resin, a polyamide-based resin, a polyimide-based resin, polyether ether ketone and polyphenylene sulfide); a rubber-based substrate such as a rubber sheet; and an appropriate thin leaf body such as a foam body such as foam sheet or a laminated body thereof may be used. The substrate may have a single layer form, or multilayer form.

From the standpoint of heat resistance, anchorage dependence of a pressure-sensitive adhesive layer, costs and the like, as the substrate, the fiber-based substrate is preferable, and the non-woven cloth is more preferable. As the non-woven cloth, a non-woven cloth from natural fibers having heat resistance may be preferably used, and among them, a non-woven cloth including Manila hemp (Manila hemp-based non-woven cloth) is more preferable.

The thickness of the substrate is not particularly limited, but is preferably 5 μm to 40 μm, more preferably 10 μm to 30 μm, and even more preferably 10 μm to 20 μm. The strength of the pressure-sensitive adhesive tape is improved by controlling the thickness to 5 μm or more. On the other hand, the product is advantageously miniaturized or made thinner by controlling the thickness to 40 μm or less.

In the case where the substrate is a non-woven cloth, the basis weight of the non-woven cloth is not particularly limited, but is preferably 5 g/m² to 15 g/m² and more preferably 6 g/m² to 10 g/m². The strength of the pressure-sensitive adhesive tape is improved by controlling the basis weight to 5 g/m² or more. On the other hand, the thickness of the substrate is easily controlled in the above range by controlling the basis weight to 15 g/m² or less.

The strength of the substrate is not particularly limited, but a tensile strength in a machine direction (MD) of the substrate is preferably 2 N/15 mm or more and more preferably 5 N/15 mm or more. The tensile strength can be measured in accordance with JIS P8113, in the same manner as in the tensile strength of the release liner.

On the surface of the substrate, if necessary, a known/general surface treatment, for example, an oxidation treatment by a chemical or physical method, such as chromate treatment, ozone exposure, flame exposure, high-pressure electrical shock exposure or ionizing radiation treatment may be performed or a coating treatment by a base coat agent may be performed, for improvement of adhesion property with the pressure-sensitive adhesive layer.

The pressure-sensitive adhesive body in the pressure-sensitive adhesive tape of the present invention may include other layers (for example, an intermediate layer, a base coat layer and the like) in addition to the pressure-sensitive adhesive layer or the substrate, in a range that does not impair the effects of the present invention.

A 180° peeling pressure-sensitive adhesive force of a pressure-sensitive adhesive surface of a pressure-sensitive adhesive body in the pressure-sensitive adhesive tape of the present invention to a glass epoxy resin, measured at a tensile speed of 300 mm/min, is not particularly limited, but is preferably 8 N/20 mm or more (for example, 8 N/20 mm to 30 N/20 mm) and more preferably 10 N/20 mm to 30 N/20 mm. The tape can be firmly fixed to an adherend by controlling the 180° peeling pressure-sensitive adhesive force to 8 N/20 mm or more. In the case where the pressure-sensitive adhesive tape of the present invention is a double-sided pressure-sensitive adhesive tape, when the pressure-sensitive adhesive surface is laminated to a glass epoxy resin, it is preferred that the 180° peeling pressure-sensitive adhesive force satisfies the above range evening both pressure-sensitive adhesive surfaces. The 180° peeling pressure-sensitive adhesive force may be measured, for example, by performing a 180° peel test (the laminate is pressure-contacted by moving a 2-kg rubber roller back and forth once, tensile speed: 300 mm/min) of a pressure-sensitive adhesive tape (pressure-sensitive adhesive body), when a glass epoxy resin (glass epoxy substrate, trade name “FR-4”, manufactured by Hitachi Chemical Co., Ltd.) is used as an adherend, in accordance with JIS Z0237 (2000) by using a tensile tester under an atmosphere of 23° C. and 50% RH.

The 180° peeling pressure-sensitive adhesive force may be controlled by a monomer composition or molecular weight of an acrylic polymer, a kind or adding amount of a tackifying resin, and the like.

[Pressure-Sensitive Adhesive Tape]

The pressure-sensitive adhesive tape of the present invention has a configuration that the release liner of the present invention is provided on at least one pressure-sensitive adhesive surface of the pressure-sensitive adhesive body. That is, the pressure-sensitive adhesive tape of the present invention has at least a pressure-sensitive adhesive body and the release liner of the present invention provided on at least one pressure-sensitive adhesive surface of the pressure-sensitive adhesive body.

The pressure-sensitive adhesive tape of the present invention may be manufactured by a known/general method, and the manufacturing method thereof is not particularly limited, but for example, in the case where the pressure-sensitive adhesive body in the pressure-sensitive adhesive tape of the present invention does not have a substrate, the pressure-sensitive adhesive tape of the present invention may be manufactured by, for example, forming a pressure-sensitive adhesive layer on the release liner of the present invention. On the other hand, in the case where the pressure-sensitive adhesive body in the pressure-sensitive adhesive tape of the present invention has a substrate, for example, the formation of the pressure-sensitive adhesive layer may be performed by a method (direct scan technique) of directly forming a pressure-sensitive adhesive layer on the surface of the substrate or by a method (transfer technique) of forming a pressure-sensitive adhesive layer on the release liner of the present invention, and transferring (laminating) it to the substrate (transcribing method).

Since the pressure-sensitive adhesive tape of the present invention has the release liner of the present invention having a tensile strength (initial stage) in a machine direction and a tensile strength (after heating) in a machine direction, which are controlled in the above-described ranges, even in the case where the FPC to which a pressure-sensitive adhesive tape including the release liner of the present invention is laminated is subjected to a high temperature process such as a solder reflow process, the release liner of the present invention can be released without being torn off even after the high temperature process, and thus excellent release workability can be exhibited. On this account, if the pressure-sensitive adhesive tape of the present invention is used, the productivity or quality of an electronic device is improved.

In the pressure-sensitive adhesive tape of the present invention, the release liner may be released from the surface of the pressure-sensitive adhesive layer without being torn off (broken) when the release liner (width: 30 mm) of the present invention is released under conditions of a release angle of 90° and a tensile speed of 300 mm/min after heating at 280° C. for 5 min. Accordingly, the pressure-sensitive adhesive tape of the present invention has excellent release workability of the release liner even after being subjected to a high temperature process such as a solder reflow process. The release of the release liner of the present invention may be performed, for example, by using a pressure-sensitive adhesive tape cut in a size of a width of 30 mm and a length of 130 mm in accordance with JIS Z0237 (2000) by using a tensile tester under an atmosphere of 23° C. and 50% RH.

It is preferred that the pressure-sensitive adhesive tape of the present invention is a pressure-sensitive adhesive tape having a pull tab (pull tab-processed pressure-sensitive adhesive tape) from the standpoint of release easiness of the release liner. The pull tab (pull tab for release) refers to a part used as a region for holding the release liner when the release liner is released from the pressure-sensitive adhesive tape, and the release liner is easily released by having the pull tab.

The pull tab is typically configured by a part in which some of the periphery of the release liner in the pressure-sensitive adhesive tape is protruded from the pressure-sensitive adhesive body (this part is not in contact with the pressure-sensitive adhesive body). Among them, it is preferred that the pull tab is formed by protruding at least some of the release liner of the present invention from the pressure-sensitive adhesive body. Specifically, it is preferred that, for example, the pull tab in the pressure-sensitive adhesive tape of the present invention is formed by protruding some or all of the end portion of the release liner of the present invention in a machine direction from the pressure-sensitive adhesive body.

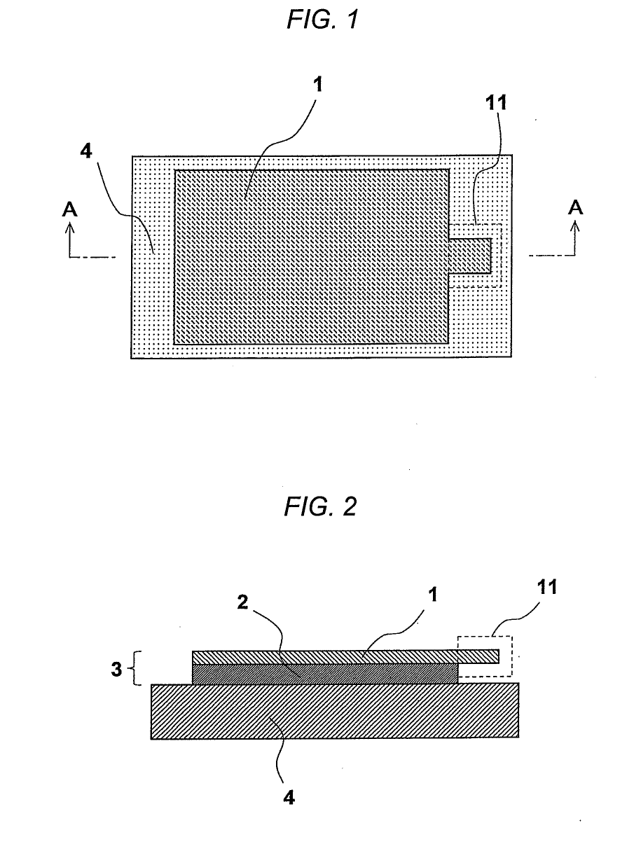

FIG. 1 shows a schematic view (plan view) illustrating an example of a state in which the pressure-sensitive adhesive tape of the present invention having a pull tab (pressure-sensitive adhesive tape having a pull tab for releasing the release liner of the present invention) is laminated to an adherend. FIG. 2 is an A-A cross-sectional view in FIG. 1. In FIGS. 1 and 2, reference numeral 1 represents the release liner of the present invention and reference numeral 11 represents a pull tab (pull tab for release). Reference numeral 2 represents a pressure-sensitive adhesive body in the pressure-sensitive adhesive tape of the present invention, and reference numeral 3 represents a pressure-sensitive adhesive tape (double-sided pressure-sensitive adhesive tape). Reference numeral 4 represents an adherend such as a housing of FPC or an electronic part, and a pressure-sensitive adhesive surface on one side of the pressure-sensitive adhesive tape 3 is laminated to the surface thereof. In the pressure-sensitive adhesive tape 3 shown in FIGS. 1 and 2, the release liner 1 of the present invention can be easily released by holding and pulling up the pull tab 11. In this way, the pull tab may be formed to exhibit much better release workability.

The size of the pull tab is not particularly limited, but as shown in FIG. 1, the pull tab is generally formed in a shape having a width narrower than the width of the pressure-sensitive adhesive tap from the standpoint of easily holding the pull tab during the release work. The position on which the pull tab is to be formed, or the number of the pull tab may be properly selected according to a use aspect of the pressure-sensitive adhesive tape, and is not particularly limited.

The pull tab is not particularly limited, and may be formed by a known/general method for forming a pull tab (pull tab processing method). Examples of the method for manufacturing the pressure-sensitive adhesive tape of the present invention having a pull tab include a method of cutting only a separator and a pressure-sensitive adhesive layer on one side to release the separator and pressure-sensitive adhesive layer cut (that is, the pull tab is configured by some of the separator on a side on which the separator and pressure-sensitive adhesive layer are not cut) when the pressure-sensitive adhesive tape having the separator formed on both pressure-sensitive adhesive surfaces of the pressure-sensitive adhesive layer (double-sided pressure-sensitive adhesive body) is subjected to punching processing.

As described above, defects that the release liner is torn off or broken are not caused when the release liner of the present invention is released after being subjected to a high temperature process, and thus, the pressure-sensitive adhesive tape of the present invention has excellent release workability. In the case where the pressure-sensitive adhesive tape of the present invention has a pull tab, defects that the release liner is torn off or broken are not caused when the release liner of the present invention is released after the high temperature process, and also the release liner is easily released by the pull tab, and thus, the pressure-sensitive adhesive tape of the present invention exhibits much better release workability.

On the other hand, the pressure-sensitive adhesive tape in the related art had a problem in that defects that the release liner is torn off or broken are caused by heat deterioration of the release liner when the release liner is released after being subjected to a high temperature process. In particular, in the case where the pressure-sensitive adhesive tape in the related art has a pull tab for the purpose of release easiness, defects that a pull tab part formed by a relatively narrow width is easily torn off or broken, and thus, release workability is significantly deteriorated has been caused.

The pressure-sensitive adhesive tape of the present invention is a pressure-sensitive adhesive tape for a flexible printed circuit (pressure-sensitive adhesive tape for fixing a flexible printed circuit), which is used for fixing an FPC to an adherend. The adherend to which an FPC is fixed by the pressure-sensitive adhesive tape of the present invention is not particularly limited, but examples thereof include a housing, a motor, a base, a substrate, a cover and the like of a mobile phone. A hard disk drive, a mobile phone, a motor and the like are manufactured by using the pressure-sensitive adhesive tape of the present invention to laminate and fix the FPC to the above-described adherend.

The flexible printed circuit (FPC) is not particularly limited, but includes an electric insulator layer (referred to as a “base insulation layer” in some cases), an electric conductor layer formed on the base insulator layer (referred to as a “conductor layer” in some cases) so as to give a predetermined circuit pattern, and, if necessary, an electric insulator layer (referred to as a “cover insulation layer” in some cases) for covering, which is formed on the conductor layer. The flexible printed circuit may have a multilayer structure in which a plurality of circuit substrates are laminated.

The base insulation layer is an electric insulator layer formed by an electric insulating material. The electric insulating material for forming a base insulation layer is not particularly limited, and may be properly selected from electric insulating materials employed in known flexible printed circuits. Preferable specific examples thereof include a plastic material such as a polyimide-based resin, an acrylic resin, a polyether nitrile-based resin, a polyether sulfone-based resin, a polyester-based resin (such as a polyethylene terephthalate-based resin and a polyethylene naphthalate-based resin), a polyvinyl chloride-based resin, a polyphenylene sulfide-based resin, a polyetheretherketone-based resin, a polyamide-based resin (such as the so-called “aramid resin”), a polyarylate-based resin, a polycarbonate-based resin and a liquid crystal polymer. The electric insulating material may be used either alone or in combination of two or more thereof. Among them, a polyimide-based resin is suitable. The base insulation layer may have any form of a single layer and a multilayer. On the surface of the base insulation layer, various surface treatments (for example, corona discharge treatment, plasma treatment, treatment for making the surface rough, hydrolysis treatment and the like) may be performed. The thickness of the base insulation layer is not particularly limited, but is preferably 3 μm to 100 μm, more preferably 5 μm to 50 μm, and even more preferably 10 μm to 30 μm.

The conductor layer is an electric conductor layer formed by an electric conducting material. The conductor layer is formed on the base insulation layer so as to have a predetermined circuit pattern. The electric conducting material for forming the conductor layer is not particularly limited, and may be properly selected from electric conducting materials employed in known flexible printed circuits. Specific examples of the electric conducting material include a metal material such as copper, nickel, gold, chromium, various alloys (such as solder) and platinum, an electric conductive plastic material and the like. The electric conducting material may be used either alone or in combination of two or more thereof. Among them, metal materials (in particular, copper) are suitable. The conductor layer may have any form of a single layer and a multilayer. On the surface of the conductor layer, various surface treatments may be performed. The thickness of the conductor layer is not particularly limited, but is preferably 1 μm to 50 μm, more preferably 2 μm to 30 μm, and even more preferably 3 μm to 20 μm.

The forming method of the conductor layer is not particularly limited, but may be properly selected from known forming methods (for example, known patterning methods such as a subtractive method, an additive method and a semi-additive method). For example, in the case where the conductor layer is formed directly on the surface of the base insulation layer, the conductor layer may be formed by plating or depositing the electric conducting material on the base insulation layer by using a non-electrolytic plating method, an electrolytic plating method, a vacuum vapor deposition method, or a sputtering method so as to have a predetermined circuit pattern.

The cover insulation layer is an electric insulator layer for covering (electric insulator layer for protection) which is formed by an electric insulating material and covers the conductor layer. The cover insulation layer is disposed if necessary, and is not always disposed. The electric insulating material for forming the cover insulation layer is not particularly limited, but may be properly selected from electric insulating materials employed in known flexible printed circuits, in the same manner as the case of the base insulation layer. Specific examples of the electric insulating material for forming the cover insulation layer include the electric insulating material which is exemplified as an electric insulating material for forming the above base insulation layer, and the like. In the same manner as the case of the base insulation layer, a plastic material (in particular, a polyimide-based resin) is suitable. The electric insulating material for forming the cover insulation layer may be used either alone or in combination of two or more thereof. The cover insulation layer may have any form of a single layer and a multilayer. On the surface of the cover insulation layer, various surface treatments (for example, corona discharge treatment, plasma treatment, treatment for making the surface rough, hydrolysis treatment and the like) may be performed. The thickness of the cover insulation layer is not particularly limited, but is preferably 3 to 100 μm, more preferably 5 μm to 50 μm, and even more preferably 10 μm to 30 μm.

The forming method of the cover insulation layer is not particularly limited, but may be properly selected from known forming methods (for example, a method where a liquid substance or melted substance containing an electric insulating material is applied, followed by drying, a method where a film or sheet which corresponds to the shape of the conductor layer and is formed by an electric insulating material is laminated, and the like).

Hereinafter, the present invention will be described in more detail based on Examples, but the present invention is not limited to the Examples.

### Example 1

### Preparation of Pressure-Sensitive Adhesive Composition

90 parts by weight of 2-ethylhexyl acrylate (2EHA) and 10 parts by weight of acrylic acid (AA) were subjected to a solution polymerization treatment in 210 parts by weight of ethyl acetate while stirring at 60° C. to 80° C. in the presence of 0.4 part by weight of 2,2′-azobisisobutyronitrile and under substitution with nitrogen, thereby preparing an acrylic polymer solution (viscosity: about 120 poises, degree of polymerization: 99.2%, and solid matter: 30.0 wt %) containing an acrylic polymer.

20 parts by weight of a terpene-phenol-based tackifying resin (trade name “YS POLYSTER S145”, manufactured by Yasuhara Chemical Co., Ltd., softening point 145° C.) and 0.05 parts by weight of an epoxy-based crosslinking agent (trade name “Tetrad-C”, manufactured by Mitsubishi Gas Chemical Company, Inc.) based on 100 parts by weight of the acrylic polymer were added and mixed in the acrylic polymer solution, thereby obtaining a pressure-sensitive adhesive composition.

(Manufacture of Release Liner)

As a liner substrate, a heat resistant resin coated paper (trade name of “HCB-90(WH)” manufactured by Tomoegawa Paper Co., Ltd.) was used. As a silicon-based release agent, a thermosetting silicon-based release agent [a mixture of trade name “AST-8” (manufactured by Arakawa Chemical Industries, Ltd.) and trade name “CATA12070” (manufactured by Bluestar Silicones)] was used. A release liner was manufactured by applying the silicon-based release agent on one surface of the liner substrate in a coated amount (converted as solid matter) of 2.5 g/m², heating at 120° C. for 1 min, followed by aging at 50° C. for 72 hours, thereby forming a release treatment layer.

Manufacture of Double-Sided Pressure-Sensitive Adhesive Tape

A pressure-sensitive adhesive tape (substrateless double-sided pressure-sensitive adhesive tape) was obtained by applying the pressure-sensitive adhesive composition on the surface of the release liner (surface on the release treatment layer side), followed by drying at 130° C. for 5 min, thereby forming a pressure-sensitive adhesive layer having a thickness of 30 μm.

### Comparative Example 1

As shown in Table 1, a pressure-sensitive adhesive tape (substrateless double-sided pressure-sensitive adhesive tape) was obtained in the same manner as in Example 1, except that the liner substrate was changed into craft paper (trade name “Craft OPK”, manufactured by Oji Paper Co., Ltd.).

(Evaluation)

Measurement or evaluation was performed on the pressure-sensitive adhesive tapes obtained in the Example and Comparative Example by the following measurement method or evaluation method. The results are shown in Table 1.

(1) Tensile Strength of Release Liner (Initial Stage)

A strip sample for measurement was prepared by releasing a release liner from the pressure-sensitive adhesive tape obtained in the Example and Comparative Example and cutting the release liner in a size of a width of 10 mm and a length of 100 mm. The sample for measurement was cut such that the machine direction of the release liner (that is, the machine direction of the pressure-sensitive adhesive tape) becomes the machine direction of the sample for measurement.

The tensile strength was measured by pulling the sample for measurement in a machine direction at a tensile speed of 300 mm/min in a distance between chucks (initial length) of 100 mm by using a tensile tester under an atmosphere of 23° C. and 50% RH. Each average value was calculated by setting the number of tests (n number) to three. The results are shown in the “Initial stage” column of “Tensile strength of release liner” in Table 1.

(2) Tensile Strength of Release Liner (after Heating)

A strip sample piece was obtained by releasing a release liner from the pressure-sensitive adhesive tape obtained in the Example and Comparative Example and cutting the release liner in a size of a width of 10 mm and a length of 100 mm. The sample piece was cut such that the machine direction of the release liner (that is, the machine direction of the pressure-sensitive adhesive tape) becomes the machine direction of the sample piece. Subsequently, the sample piece was heated at 280° C. in an oven for 5 min to prepare a sample for measurement.

The tensile strength was measured by pulling the sample piece for measurement in a machine direction at a tensile speed of 300 mm/min in a distance between chucks (initial length) of 100 mm by using a tensile tester under an atmosphere of 23° C. and 50% RH.

Each average value was calculated by setting the number of tests (n number) to three. The results are shown in the “After heating” column of “Tensile strength of release liner” in Table 1.

(3) Dimensional Change Rate of Release Liner

A sample for measurement was prepared by releasing a release liner from the pressure-sensitive adhesive tape obtained in the Example and Comparative Example and cutting the release liner in a size of a width of 240 mm and a length of 240 mm. The sample for measurement was cut such that the machine direction of the release liner (that is, the machine direction of the pressure-sensitive adhesive tape) becomes the machine direction of the sample for measurement.

Subsequently, the sample for measurement was left to stand under an atmosphere of 23° C. and 50% RH for 2 hours by using a constant temperature and constant humidity bath, and a gauge line was inserted (gauge line interval: Lₒ (about 240 mm)). Subsequently, the sample for measurement was transferred under an atmosphere of 60° C. and 90% RH, and the sample was left to stand for 24 hours, followed by measurement of the gauge line interval (Lᵢ) to calculate a dimensional change rate according to the following equation.

Dimensional change rate(%)=(L₁−L₀)/L₀×100

The measurement of the dimensional change rate was performed in both a machine direction and a transverse direction of the sample for measurement (that is, both a machine direction and a transverse direction of the release liner). The results are each shown in the “Dimensional change rate of release liner” column in Table 1.

(4) Whether Release Liner is Torn Off (Release Workability)

The pressure-sensitive adhesive tape obtained in the Example and Comparative Example was cut in a size of a width of 10 mm and a length of 100 mm, and the cut tape was heated at 280° C. for 5 min. Subsequently, a release liner was released from the pressure-sensitive adhesive tape after heating. The state of the release liner during release (whether there is a break (torn off)) was confirmed to evaluate the release workability of the release liner after being subjected to a high temperature process, according to the following criteria. The results are shown in the “Whether release liner is torn off” column in Table 1.

A (Good release workability): No break (torn off) in release liner

B (Poor release workability): Break (torn off) in release liner

TABLE 1

| | | | Comparative |
|---|---|---|---|
| | | Example 1 | Example 1 |
| Liner substrate | Kind | Heat | Craft paper |
| | | resistant | |
| | | resin | |
| | | coated | |
| | | paper | |
| | Basis weight [g/m²] | 90 | 73 |
| | Thickness [μm] | 115 | 120 |
| Tensile strength | Initial stage [MPa] | 72 | 50 |
| of release liner | After heating [MPa] | 59 | 9 |
| Dimensional | Machine direction [%] | 0.03 | 0.09 |
| change rate of | Transverse direction [%] | 0.34 | 0.39 |
| release liner | | | |

| | | |
|---|---|---|
| Whether release liner is torn off | A | B |

As apparent from the results in Table 1, the release liner of the pressure-sensitive adhesive tape in the Example had high tensile strength both in a machine direction (initial stage) and in a machine direction (after heating) and excellent release workability without being torn off even in the case where the release liner is released after being subjected to a high temperature process. On the other hand, in the case where the tensile strength of the release liner in a machine direction (after heating) is excessively low (Comparative Example), the release liner is torn off in the case where the release liner is released after being subjected to the high temperature process, and thus, the release workability is deteriorated.

While the invention has been described in detail and with reference to specific embodiments thereof, it will be apparent to one skilled in the art that various changes and modifications can be made therein without departing from the spirit and scope thereof.

This application is based on Japanese Patent Application No. 2011-096181 filed on Apr. 22, 2011, the entire subject matter of which is incorporated herein by reference.

The present invention provides the following pressure-sensitive adhesive tape for a flexible printed circuit.

(1) A pressure-sensitive adhesive tape for a flexible printed circuit, comprising:

a pressure-sensitive adhesive layer; and

a release liner on at least one surface of the pressure-sensitive adhesive layer,

wherein a tensile strength of the release liner in a machine direction is 50 MPa to 150 MPa, and a tensile strength of the release liner in a machine direction after heating at 280° C. for 5 min is 20 MPa to 120 MPa.

(2) The pressure-sensitive adhesive tape according to (1), wherein the release liner comprises: a glassine paper or a resin coated paper; and a release treatment layer formed by a silicon-based release agent on at least one surface of the glassine paper or the resin coated paper.

(3) The pressure-sensitive adhesive tape according to (1) or (2), wherein the pressure-sensitive adhesive layer comprises, as an essential component, an acrylic polymer formed from a monomer component comprising an acrylic monomer represented by the following formula (I) in an amount of 50 wt % or more based on an entire monomer component (100 wt %) forming the acrylic polymer:

CH₂═C(R¹)COOR² (I)

wherein R¹ represents a hydrogen atom or a methyl group, and R² represents an alkyl group having 4 to 14 carbon atoms.

(4) The pressure-sensitive adhesive tape according to any one of (1) to (3), wherein dimensional change rates of the release liner in both a machine direction and a transverse direction before and after storage for 24 hours under an atmosphere of 60° C. and 90% RH are 2.0% or less.

(5) The pressure-sensitive adhesive tape according to any one of (1) to (4), wherein when the pressure-sensitive adhesive tape is cut to have a size of a width of 30 mm and a length of 130 mm, the cut pressure-sensitive adhesive tape is heated at 280° C. for 5 min, and then, the release liner is released from the surface of the pressure-sensitive adhesive layer under the conditions of a release angle of 90° and a tensile speed of 300 mm/min, the release liner can be released from the surface of the pressure-sensitive adhesive layer without being torn off.

(6) The pressure-sensitive adhesive tape according to any one of (2) to (5), wherein the silicon-based release agent comprises a thermosetting silicon-based release agent.

(7) The pressure-sensitive adhesive tape according to any one of (1) to (6), which has a pull tab.

### DESCRIPTION OF REFERENCE NUMERALS AND SIGNS

1: Release liner of the present invention
11: Pull tab (pull tab for release)
2: Pressure-sensitive adhesive body
3: Pressure-sensitive adhesive tape (pressure-sensitive adhesive tape having a pull tab)
4: Adherend

What is claimed is:

1. A pressure-sensitive adhesive tape for a flexible printed circuit, comprising:
a pressure-sensitive adhesive layer; and
a release liner on at least one surface of the pressure-sensitive adhesive layer,
wherein a tensile strength of the release liner in a machine direction is 50 MPa to 150 MPa, and a tensile strength of the release liner in a machine direction after heating at 280° C. for 5 min is 20 MPa to 120 MPa.

2. The pressure-sensitive adhesive tape according to claim 1, wherein the release liner comprises: a glassine paper or a resin coated paper; and a release treatment layer formed by a silicon-based release agent on at least one surface of the glassine paper or the resin coated paper.

3. The pressure-sensitive adhesive tape according to claim 1, wherein the pressure-sensitive adhesive layer comprises, as an essential component, an acrylic polymer formed from a monomer component comprising an acrylic monomer represented by the following formula (I) in an amount of 50 wt % or more based on an entire monomer component (100 wt %) forming the acrylic polymer:
CH₂═C(R¹)COOR² (I)
wherein R¹ represents a hydrogen atom or a methyl group, and R² represents an alkyl group having 4 to 14 carbon atoms.

4. The pressure-sensitive adhesive tape according to claim 1, wherein dimensional change rates of the release liner in both a machine direction and a transverse direction before and after storage for 24 hours under an atmosphere of 60° C. and 90% RH are 2.0% or less.

5. The pressure-sensitive adhesive tape according to claim 1, wherein when the pressure-sensitive adhesive tape is cut to have a size of a width of 30 mm and a length of 130 mm, the cut pressure-sensitive adhesive tape is heated at 280° C. for 5 min, and then, the release liner is released from the surface of the pressure-sensitive adhesive layer under the conditions of a release angle of 90° and a tensile speed of 300 mm/min, the release liner can be released from the surface of the pressure-sensitive adhesive layer without being torn off.

6. The pressure-sensitive adhesive tape according to claim 2, wherein the silicon-based release agent comprises a thermosetting silicon-based release agent.

7. The pressure-sensitive adhesive tape of any one according to claim 1, which has a pull tab.

8. The pressure-sensitive adhesive tape according to claim 2, wherein the pressure-sensitive adhesive layer comprises, as an essential component, an acrylic polymer formed from a monomer component comprising an acrylic monomer represented by the following formula (I) in an amount of 50 wt % or more based on an entire monomer component (100 wt %) forming the acrylic polymer:
CH₂═C(R¹)COOR² (I)
wherein R¹ represents a hydrogen atom or a methyl group, and R² represents an alkyl group having 4 to 14 carbon atoms.

9. The pressure-sensitive adhesive tape according to claim 2, wherein dimensional change rates of the release liner in both a machine direction and a transverse direction before and after storage for 24 hours under an atmosphere of 60° C. and 90% RH are 2.0% or less.

10. The pressure-sensitive adhesive tape according to claim 3, wherein dimensional change rates of the release liner in both a machine direction and a transverse direction before and after storage for 24 hours under an atmosphere of 60° C. and 90% RH are 2.0% or less.

11. The pressure-sensitive adhesive tape according to claim 8, wherein dimensional change rates of the release liner in both a machine direction and a transverse direction before and after storage for 24 hours under an atmosphere of 60° C. and 90% RH are 2.0% or less.

12. The pressure-sensitive adhesive tape according to claim 2, wherein when the pressure-sensitive adhesive tape is cut to have a size of a width of 30 mm and a length of 130 mm, the cut pressure-sensitive adhesive tape is heated at 280° C. for 5 min, and then, the release liner is released from the surface of the pressure-sensitive adhesive layer under the conditions of a release angle of 90° and a tensile speed of 300 mm/min, the release liner can be released from the surface of the pressure-sensitive adhesive layer without being torn off.

13. The pressure-sensitive adhesive tape according to claim 3, wherein when the pressure-sensitive adhesive tape is cut to have a size of a width of 30 mm and a length of 130 mm, the cut pressure-sensitive adhesive tape is heated at 280° C. for 5 min, and then, the release liner is released from the surface of the pressure-sensitive adhesive layer under the conditions of a release angle of 90° and a tensile speed of 300 mm/min, the release liner can be released from the surface of the pressure-sensitive adhesive layer without being torn off.

14. The pressure-sensitive adhesive tape according to claim 8, wherein when the pressure-sensitive adhesive tape is cut to have a size of a width of 30 mm and a length of 130 mm, the cut pressure-sensitive adhesive tape is heated at 280° C. for 5 min, and then, the release liner is released from the surface of the pressure-sensitive adhesive layer under the conditions of a release angle of 90° and a tensile speed of 300 mm/min, the release liner can be released from the surface of the pressure-sensitive adhesive layer without being torn off.

15. The pressure-sensitive adhesive tape according to claim 4, wherein when the pressure-sensitive adhesive tape is cut to have a size of a width of 30 mm and a length of 130 mm, the cut pressure-sensitive adhesive tape is heated at 280° C. for 5 min, and then, the release liner is released from the surface of the pressure-sensitive adhesive layer under the conditions of a release angle of 90° and a tensile speed of 300 mm/min, the release liner can be released from the surface of the pressure-sensitive adhesive layer without being torn off.

16. The pressure-sensitive adhesive tape according to claim 9, wherein when the pressure-sensitive adhesive tape is cut to have a size of a width of 30 mm and a length of 130 mm, the cut pressure-sensitive adhesive tape is heated at 280° C. for 5 min, and then, the release liner is released from the surface of the pressure-sensitive adhesive layer under the conditions of a release angle of 90° and a tensile speed of 300 mm/min, the release liner can be released from the surface of the pressure-sensitive adhesive layer without being torn off.

17. The pressure-sensitive adhesive tape according to claim 10, wherein when the pressure-sensitive adhesive tape is cut to have a size of a width of 30 mm and a length of 130 mm, the cut pressure-sensitive adhesive tape is heated at 280° C. for 5 min, and then, the release liner is released from the surface of the pressure-sensitive adhesive layer under the conditions of a release angle of 90° and a tensile speed of 300 mm/min, the release liner can be released from the surface of the pressure-sensitive adhesive layer without being torn off.

18. The pressure-sensitive adhesive tape according to claim 11, wherein when the pressure-sensitive adhesive tape is cut to have a size of a width of 30 mm and a length of 130 mm, the cut pressure-sensitive adhesive tape is heated at 280° C. for 5 min, and then, the release liner is released from the surface of the pressure-sensitive adhesive layer under the conditions of a release angle of 90° and a tensile speed of 300 mm/min, the release liner can be released from the surface of the pressure-sensitive adhesive layer without being torn off.

19. The pressure-sensitive adhesive tape according to claim 8, wherein the silicon-based release agent comprises a thermosetting silicon-based release agent.

20. The pressure-sensitive adhesive tape according to claim 9, wherein the silicon-based release agent comprises a thermosetting silicon-based release agent.
